(19) United States
(12) Patent Application Publication
(10) Pub. No.: US 2005/0205703 A1
(43) Pub. Date: Sep. 22, 2005

(54) Grinder pump tank

(76) Inventors: James R. Strohecker, Annapolis, MD (US); Alan B. Hall, Dunidin, FL (US)

Correspondence Address: LAW OFFICES OF ROYAL W. CRAIG;SUITE 153, 10 NORTH CALVERT STREET, BALTIMORE, MD, 21202, US

(21) Appl. No.: 10/629,333

(22) Filed: Jul. 29, 2003

Related U.S. Application Data
(60) Provisional application No. 60/399,468, filed on Jul. 29, 2002.

(51) Int. Cl. B02C 23/36

(52) U.S. Cl. 241/46.017

(57) ABSTRACT

An improved sewage grinder pump tank inclusive of an upper tank portion formed as a cylindrical section of DR 32.5 HDPE, a lid assembly covering the upper tank portion, a lower tank portion similar to the upper tank portion, a pump platform section in communication with the upper tank portion and lower tank portion and forming a platform there between for mounting a grinder pump, and a base formed as a concave molded section for mating with the lower tank portion. The pump platform section is butt fused between the upper tank portion and the lower tank portion, and the base is butt fused to the open end of the lower tank portion. The butt fusion amalgamates the parts into one piece and avoids imperfections, thereby improving structural integrity. In addition, the grinder pump tank simplifies installation, and reduces cost.

### CROSS-REFERENCE TO RELATED APPLICATIONS

The present application derives priority from U.S. Provisional Patent Application No. 60/399,468 filed: Jul. 29, 2002.

### BACKGROUND OF THE INVENTION

1. Field of the Invention

The present invention relates to sewage grinder pumps and, more particularly, to an improved tank assemblage for a grinder pump station and method for making the same.

2. Description of the Background

Sewage grinder pump stations are well-known, as exemplified in U.S. Pat. No. 5,562,254 issued to Sleasman et al. As seen in FIG. 1 herein (taken from the '254 patent), a typical grinder pump station 10 is positioned substantially vertically in the ground. Grinder pump station 10 includes a lid assembly 22, an upper tank portion 14, a pump platform section 18, a lower tank portion 16, and a base 32. Extending through side wall 17 of pump platform section 18 is an inlet opening 20 through which sewage enters grinder pump station 10, and a discharge opening 19, through which ground sewage exits grinder pump station 10. A base 32 is secured to the lower portion 16 of grinder pump station 10. Mounted within grinder pump station 10 is a grinder pump unit 34 including a grinder head 36 for grinding sewage, and a grinder pump 39 secured to grinder head 36 for pumping ground sewage from grinder pump station 10. Upon the attainment of a predetermined sewage level, the sewage collected in grinder pump station 10 is ground by grinder head 36 and is pumped by grinder pump 39 to discharge outlet pipe 42. From discharge outlet pipe 42, the ground sewage travels to a remote location, e.g., to a pressure or gravity sewage main and ultimately to a sewage treatment plant.

With particular reference to the grinder pump tank, the tank includes tank portions 14 and 16 have a substantially cylindrical configuration. A pump platform section 18 separates the upper tank 14 from lower tank 16. Pump platform section 18 is likewise cylindrical in shape and has one or more inlet openings 20 and discharge openings 19 through its sides. Pump platform section 18 includes structure for positioning and aligning grinder pump unit 34 in grinder pump station 10. The grinder pump stations, lower tank portions, and Pump platform sections as described above and as illustrated in the '254 patent are commercially available from Environment One Corp., Schenectady, N.Y.

In the past, fiberglass has been the preferred material for grinder pump tanks because it is non-corrosive. However, several disadvantages are apparent. For example, fiberglass is a relatively expensive material. Fiberglass grinder pump stations are subject to denting and chipping as the result of shipment or installation. Such damage may not be ascertainable until after installation is complete and leaking begins. Fiberglass also has a limited ability to withstand the abrasive effects associated with sewage slurry.

In order to compensate for the various drawbacks associated with fiberglass, stations made of other materials are now available. One known non-fiberglass grinder pump station includes a station made from corrugated polyethelene pipe.

High-density polyethylene (HDPE) injection molded parts are much more durable than fiberglass, and yet it is not as easy to bond the various sections. Typically, the sections are welded by a suitable welding machine: The welding cycle is divided into 6 different phases:
PHASE 1: Bead Formation
PHASE 2: Heating up
PHASE 3: Change over
PHASE 4: Bringing up pressure
PHASE 5: Cooling Down under pressure
PHASE 6: Cooling Down out of the machine

Clearly, welding is a labor intensive process that is prone to error, and each imperfection at a seam can lead to cracks and leaks. It would be greatly advantageous to provide an HDPE grinder pump tank in which the parts to be joined are butt fused and amalgamated into one piece to avoid any imperfections, thereby improving structural integrity, simplifying installation, all at a reasonable cost.

### SUMMARY OF THE INVENTION

It is, therefore, an object of the present invention to provide an improved HDPE grinder pump tank comprising five primary components, four of which are butt fused locally and amalgamated into one piece to avoid imperfections, thereby improving structural integrity.

It is another object to provide an improved grinder pump tank as described above that utilizes repetitive sections for economy of manufacture, and specifically comprising five primary components of which four are butt fused locally and amalgamated into one piece to avoid imperfections, thereby improving structural integrity.

It is still another object to provide an improved HDPE grinder pump tank that simplifies manufacture, increases strength, all at a reasonable cost.

According to the present invention, the above-described and other objects are accomplished by providing an improved sewage grinder pump tank inclusive of an upper tank portion formed as a cylindrical section of DR 32.5 HDPE, a lid assembly covering the upper tank portion, a lower tank portion identical, except in length, to the upper tank portion, a pump platform section in communication with the upper tank portion and lower tank portion and forming a platform there between for mounting a grinder pump, and a base formed as a concave molded section for mating with the lower tank portion. The pump platform section is butt fused between the upper tank portion and the lower tank portion, and the base is butt fused to the open end of the lower tank portion. The butt fusion method amalgamates the parts into one piece and avoids imperfections, thereby improving structural strength & integrity against infiltration. In addition, the grinder pump tank simplifies installation, by allowing less stringent backfill requirements, and reduces cost.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a prior art perspective drawing of an exemplary sewage grinder pump station as shown in U.S. Pat. No. 5,562,254.

FIG. 2 is a cross-section of a grinder pump tank 10 according to the present invention.

FIG. 3 is a side perspective view of the grinder pump tank 10 as in FIG. 1.

FIG. 4 is a top view, and

FIG. 5 is a side cross-section, respectively, of the lid assembly 22.

FIG. 6 is a top view, and

FIG. 7 is a side cross-section, respectively, of the upper tank portion 14.

FIG. 8 is a top view, and

FIG. 9 is a side cross-section, respectively, of the pump platform section 18.

FIG. 10 is a top view, and

FIG. 11 is a side cross-section, respectively, of the base 32.

FIG. 12 illustrates an exemplary butt fusion machine 100 suitable for use in butt-fusing the pump platform section 18, upper tank portion 14, lower tank portion 16, and base 18 together.

### DETAILED DESCRIPTION OF THE PREFERRED EMBODIMENTS

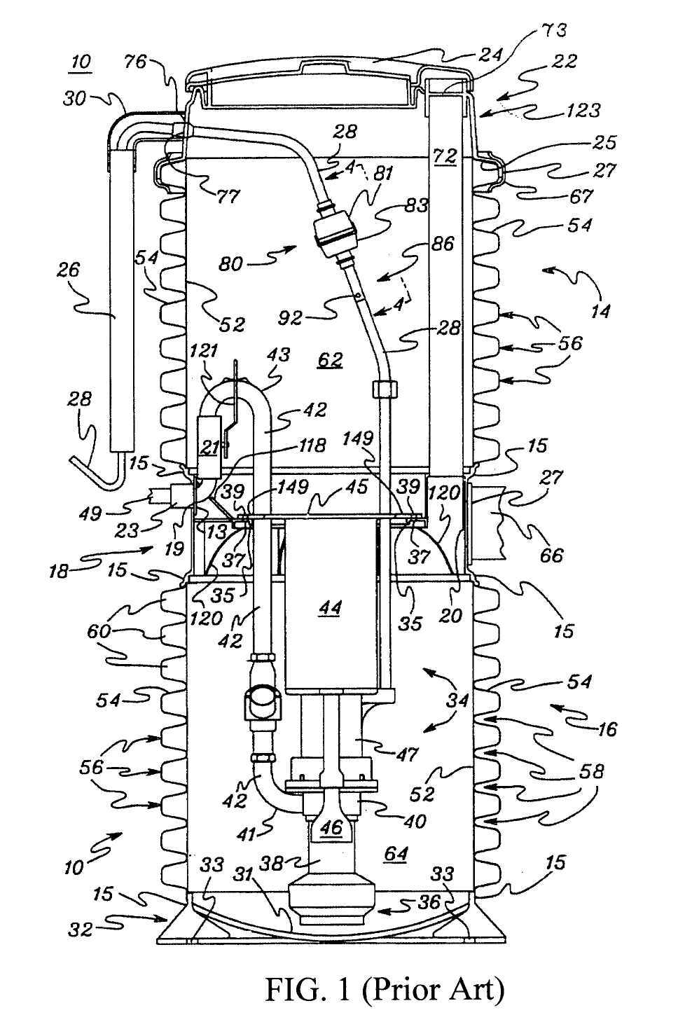

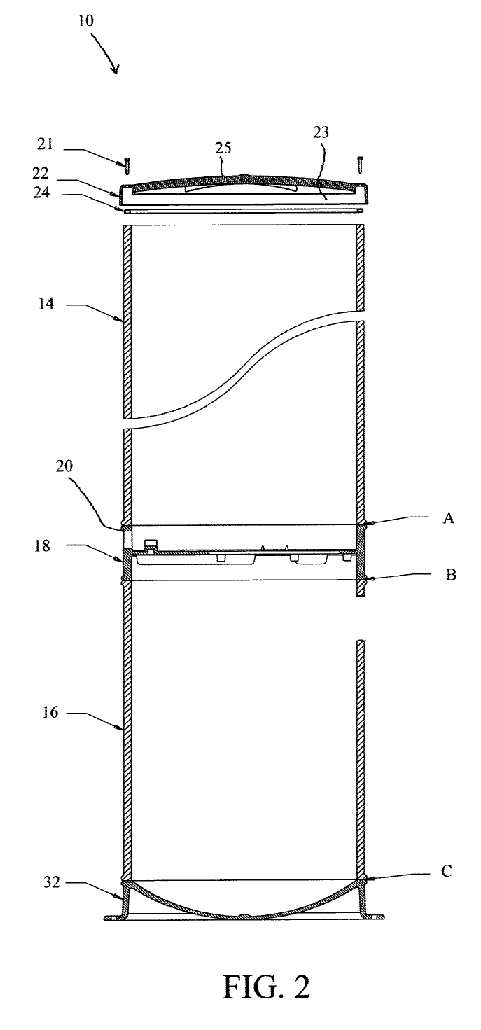

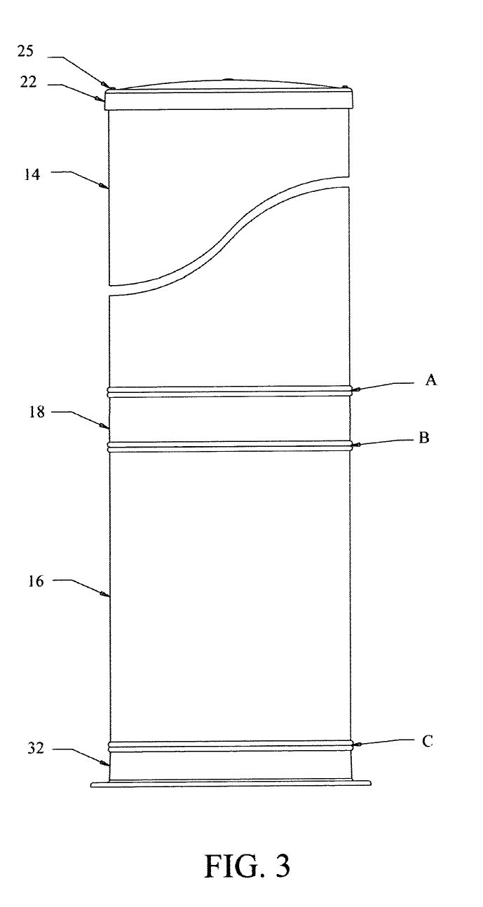

FIG. 2 is a cross-section of a grinder pump tank 10 according to the present invention, and FIG. 3 is a side perspective view of the grinder pump tank 10 as in FIG. 1.

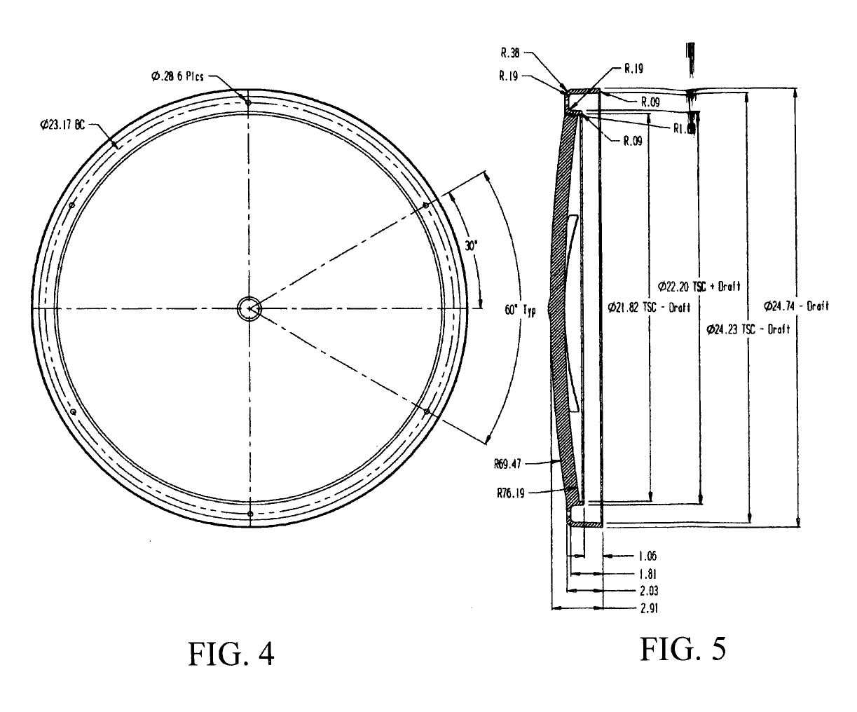

Grinder pump tank 10 includes a lid assembly 22, an upper tank portion 14, a pump platform section 18, a lower tank portion 16, and a base 32. The upper tank portion 14, lower tank portion 16 and lid assembly 22 are injection molded structural foam HDPE parts. Extending through the side wall of pump platform section 18 is an outlet opening 20 through which sewage leaves the grinder pump station 10. FIG. 4 is a top view, and FIG. 5 is a side cross-section, respectively, of the lid assembly 22. Lid assembly 22 further comprises a molded HDPE tank lid, concave inward, and having a recessed annular collar 23 for mounting atop the upper tank portion 14 via a rubber O-ring 24. Stainless steel tamper proof screws 21 are used to anchor the lid assembly 22 in place.

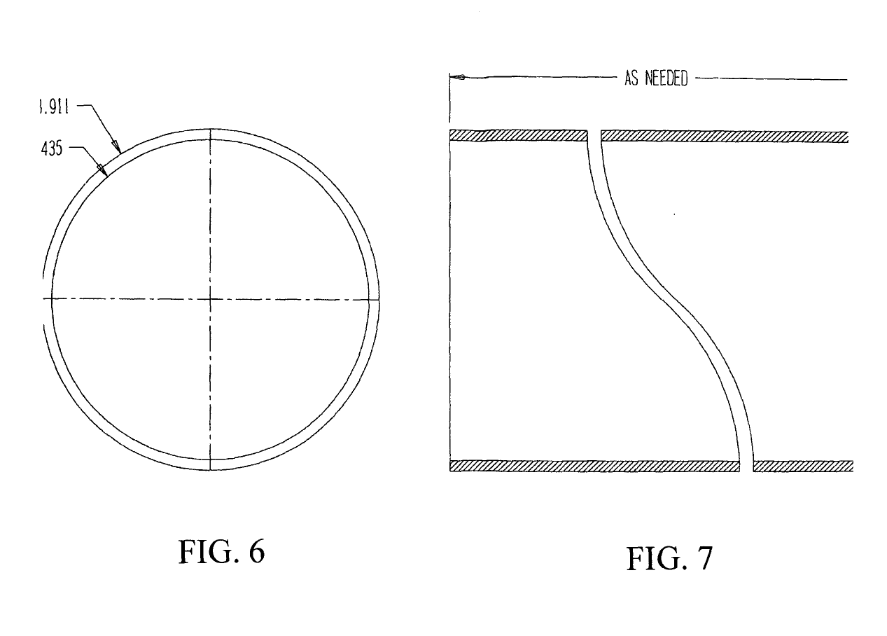

FIG. 6 is a top view, and FIG. 7 is a side cross-section, respectively, of the upper tank portion 14 (also illustrative of similar lower tank portion 16). Both the upper tank portion 14 and lower tank portion 16 are identical, except in length, cylindrical sections of DR 32.5 HDPE, respectively, for mating with the pump platform section 18. An advantage for the DR 32.5 pipe used in the present application (as compared to polyethelene corrugated pipe) is that the increased strength of the DR 32.5 HDPE pipe allows it to be used in the roadway. With a cast iron frame and cover instead of the HDPE lid, the tank structure can meet H-20 highway loading.

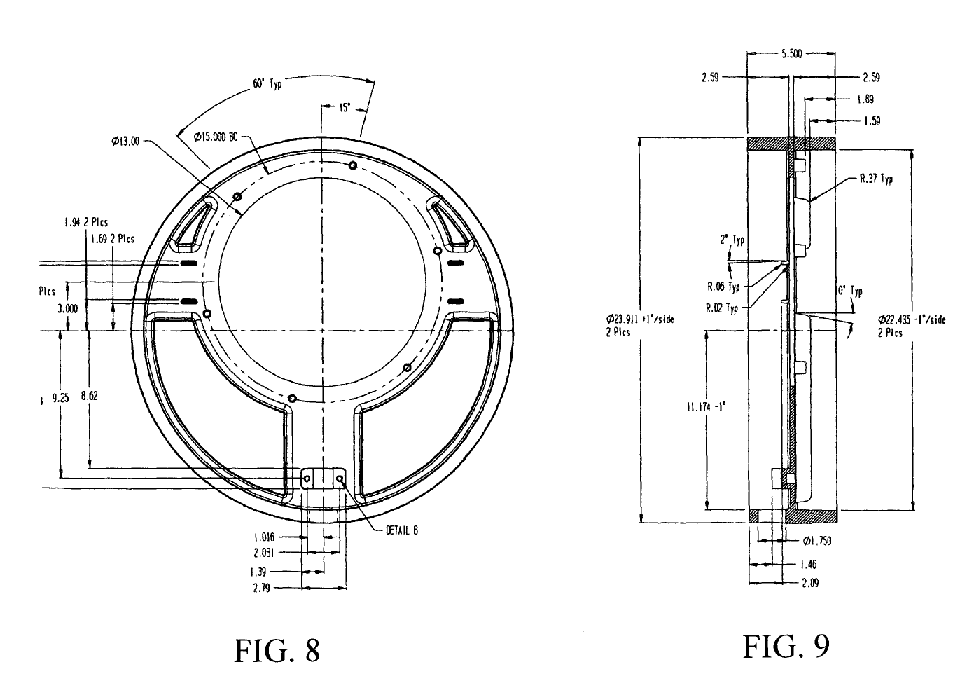

FIG. 8 is a top view, and FIG. 9 is a side cross-section, respectively, of the pump platform section 18. The pump platform section 18 separates the upper tank 14 from lower tank 16 and provides a platform for the grinder pump. Pump platform section 18 has a platform structure for positioning and aligning a grinder pump unit in the grinder pump tank 10. The particular molded pattern of the pump platform section 18 adds to its strength and helps to position the grinder pump unit relative to the core and discharge tube.

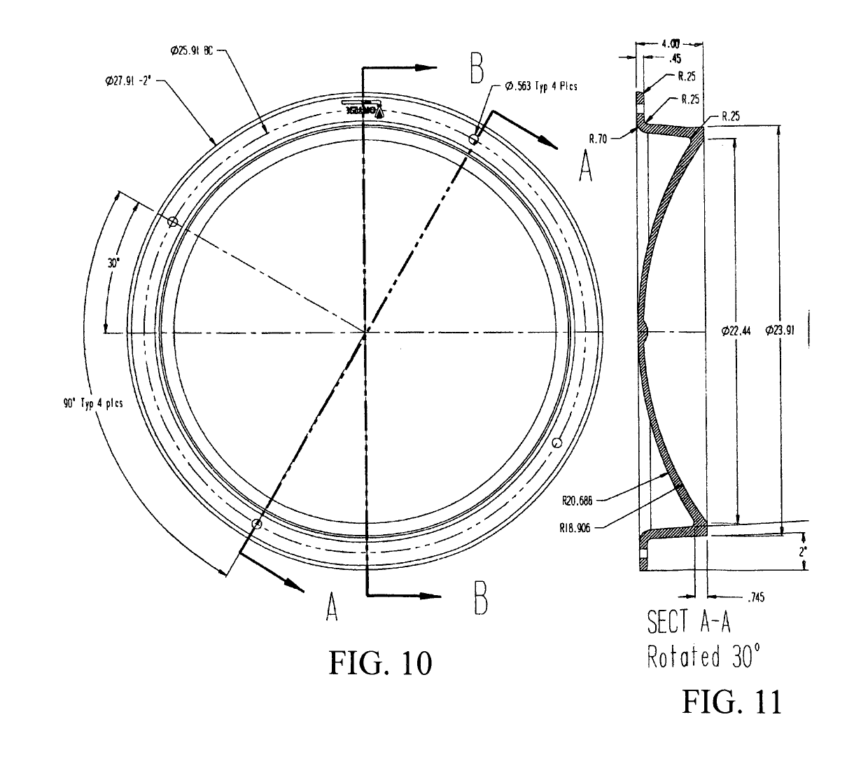

FIG. 10 is a top view, and FIG. 11 is a side cross-section, respectively, of the base 32. The base 32 is a concave-inward molded section adapted to mate with the lower tank portion 16 and having an annular stand protruding downward there from. The particular molded pattern of the base 32 adds to its strength, and the concave area keeps solids from collecting in corners.

In accordance with the present invention, the pump platform section 18 is attached to both the upper tank portion 14 and lower tank portion 16 by butt fusion method, the base 32 is then butt fused to the lower tank portion 16 in the same manner. For butt fusion, the parts to be joined are melted locally and amalgamated into one piece (or fused).

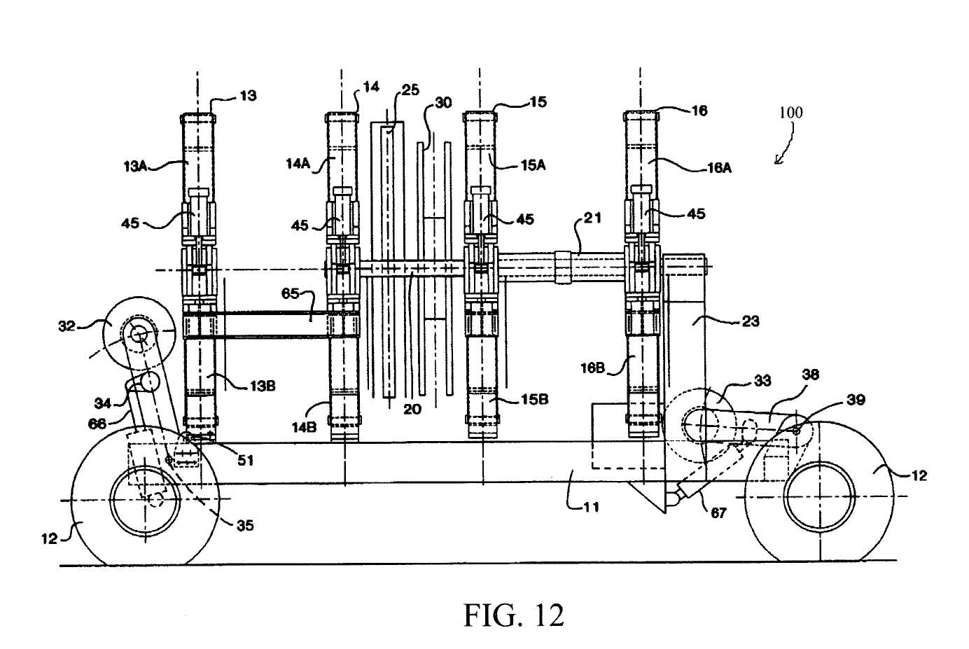

FIG. 12 illustrates an exemplary butt fusion machine 100 shown in the position in which the pump platform section 18, upper tank portion 14, and lower tank portion 16 are butt fused together. The pump platform section 18 is inserted into the movable jaws 15 and 16 when the upper jaw halves 15A and 16A are pivoted away from the lower jaw halves 15B and 16b. The roller 33 may be used to move the pipe into the jaws 15 and 16, and to lift the pipe to the proper height. After the pump platform section 18 is properly positioned, the upper jaw halves 15A, 16B are closed and hydraulically locked into place through the action of the cylinder assemblies 45.

The upper tank portion 14 is inserted into the stationary jaws 13 and 14 when the upper jaw halves 13A and 14A are pivoted away from the lower jaw halves 13B and 14b. The roller 32 may be used to move the upper tank portion 14 into or out of the jaws 13 and 14, and to lift the upper tank portion 14 to the proper height. After the upper tank portion 14 is properly positioned, the upper jaw halves 13A, 14A are closed and mechanically locked into place around the upper tank portion 14 by the hydraulic cylinder assemblies 45 so that it is immovably held. Fine adjustments are made to place the pump platform section 18 and upper tank portion 14 in exact axial alignment with each other and at an exact distance from each other. After alignment of the pipes are completed, the facing tool 30 is pivoted into the space between the sections and rotated to properly face the sections to provide a perfectly flat, properly aligned face on the surfaces to be butt fused. After facing takes place, the pump platform section 18 in the movable jaws 15 and 16 is repositioned and the heating assembly 25 is pivoted into the space between the pump platform section 18 and upper tank portion 14 and the edges are heated to the proper temperature in accordance with the following chart. When proper temperature has been reached, the heating assembly 25 is pivoted out of the space between the pump platform section 18 and upper tank portion 14, and the pump platform section 18 is shifted axially forward in the movable jaws 15 and 16 towards the upper tank portion 14 in the jaws 13 and 14. When the adjacent edges of the pipes meet, the melted plastic merges, and forms a completely integrated, unitary mass and a uniform circumferential fusion bead forms on both sides of the joint A as shown at FIG. 1. This position is held in accordance with the following butt fusion parameter chart until the plastic has cooled and hardened. The jaws 13-16 are opened and the butt fusion machine 100 is driven forward along the pipeline run to a point forward of the joint in preparation for butt fusion welding of the pump platform section 18 and lower tank portion 16 as shown at point B in FIG. the next section of pipe. Finally, the base 32 is butt fused to the pump platform section 18 as shown at point C in exactly the same manner.

Each butt fusion process is carried out in the stages shown in the following Chart:

[image]

and subject to the parameters show in the following Table to ensure a high-integrity weld.

| ¹Butt Fusion Parameter | | Units | Value | Comments |
|---|---|---|---|---|
| Heater plate temperature | | degrees C. | 220″ 15 | |
| Pressure value: Bead up | P1 | kPa | 175″ 25 | Insert this value in the formula |
| | | | | (note 6), and add drag pressure |
| Approx. bead width after bead up | | mm | 0.5 + 0.1 t | t = wall thickness (see note 4) |
| Bead up time | T1 | second | Approx. 6 t | Varies with ambient temp. |
| Pressure value: Heat soak | P2 | kPa | Drag only | |
| Heat soak time | T2 | second | 15 t | |
| Max. changeover time | T3 | second | 3 + 0.01 D | D = pipe diameter (see note 5). |
| Max. time to achieve welding | T4 | second | 3 + 0.03 D | Pressure should be increased |
| pressure | | | | smoothly using most of the time |
| | | | | allowed to reach weld pressure. |
| Pressure value: Welding & | P3 | kpa | 175″ 25 | Insert this value in the formula |
| Cooling | | | | (note 6), and add drag pressure |
| Welding & cooling time: | T5 | minute | 10 + 0.5 t | Time in clamps |
| t < 15 mm | | | | |
| Welding & cooling time: | T5 | minute | 1.5 t | Time in clamps |
| t > 15 mm | | | | |
| Min. bead width after cooling | | mm | 3 + 0.5 t | Typical. (See note 2) |
| Max. bead width after cooling | | mm | 5 + 0.75 t | Typical. (See note 2) |

Notes:
¹These parameters apply to the butt fusion of polyethylene materials as specified in AS/NZS 4131.
2. These parameters may also apply to the butt fusion of PE80 to PE100. This may result in slightly different bead formation without reducing weld quality. If in doubt refer to the pipemaker.
3. Only pipes and fittings of the same diameter and wall thickness should be butt fused together.
4. t = mean pipe wall thickness calculated from AS4130 min/max values, rounded to the nearest mm.
5. D = mean pipe outside diameter calculated from AS4130 min/max values, rounded to the nearest mm.
6. Pressure calculation formula: where pipe annulus area = p (D − t)t
7. For ambient temperature > 25° C., cooling time must be increased by 1 minute per ° C. above 25° C.
8. For ambient temperature < 5° C., cooling time may be decreased by 1 minute per ° C. below 5° C.

Once fully assembled, the grinder pump tank 10 is positioned substantially vertically in the ground. The butt fusion amalgamates the parts into one piece and avoids imperfections, thereby improving structural integrity. In addition, the grinder pump tank simplifies installation, and reduces cost.

Having now fully set forth the preferred embodiments and certain modifications of the concept underlying the present invention, various other embodiments of the lateral-mount lower tank as well as certain variations and modifications thereto may obviously occur to those skilled in the art upon becoming familiar with said underlying concept. It is to be understood, therefore, that the invention may be practiced otherwise than as specifically set forth herein.

1. A sewage grinder pump tank, comprising:
an upper tank portion formed as a cylindrical section of DR 32.5 HDPE;
a lid assembly covering said upper tank portion;
a lower tank portion similar to said upper tank portion;
a pump platform section in communication with said upper tank portion and lower tank portion and forming a platform there between for mounting a grinder pump; and
a base formed as a concave molded section for mating with the lower tank portion;
said pump platform section being fusion butt fused to one end of the upper tank portion and to one end of the lower tank portion, and said base being butt fussed to another end of the lower tank portion.
